(19) United States
(12) Patent Application Publication
(10) Pub. No.: US 2016/0348492 A1
(43) Pub. Date: Dec. 1, 2016

(54) SYSTEM AND METHOD FOR REDUCING SALT WATER INTRUSION INTO AN AQUIFER

(71) Applicant: Edison International, Rosemead, CA (US)

(72) Inventor: Daniel Stephen Chase, Glendale, CA (US)

(21) Appl. No.: 14/843,189

(22) Filed: Sep. 2, 2015

Related U.S. Application Data
(60) Provisional application No. 62/167,468, filed on May 28, 2015.

(51) Int. Cl. E21B 43/40; C02F 1/44; E21B 43/34

(52) U.S. Cl. CPC E21B 43/40; E21B 43/34; C02F 1/441; C02F 2103/06

(57) ABSTRACT

A system for reducing salt water intrusion into a fresh water aquifer includes: a) generating means for removing brackish water from the aquifer via an brackish water extraction well at a first distance from the ocean; b) removal means for introducing the removed brackish water into a desalination system to generate a first stream of water with a first salt content and a second stream of water having a second salt content, the first salt content being less than the second salt content and less than the salt content of the removed brackish water; and c) introduction means for introducing at least a portion of the first stream of water into the aquifer via a barrier well at a second distance from the ocean, the second distance being greater than the first distance.

### CROSS-REFERENCE TO RELATED APPLICATION

This application claims the benefit of U.S. Provisional Patent Application No. 62/167,468 titled “Method For Reducing Salt Water Intrusion Into a Fresh Water Aquifer” filed May 28, 2015, the contents of which are incorporated in this disclosure by reference in their entirety.

### BACKGROUND

Groundwater withdrawal from aquifers beneath Southern California and other coastal communities has outstripped recharge from rainwater over the past many decades. As a result of this “water mining,” the water table has been drawn down to unprecedented levels—requiring ever-deeper and less productive water wells.

Along the coast, freshwater aquifers typically cross the shoreline at some depth where the water they carry traditionally discharges up through ocean floor and mixes with seawater—owing to the historically greater water pressure in the aquifer driven by mountain run-off rain water and subsequent percolation through the basin floor into the aquifers below.

With the increase of freshwater withdrawal from these aquifers, the freshwater pressure in the aquifers at the shoreline tends to drop—sometimes to the point where seawater percolates into freshwater aquifers at depth offshore and pushes onshore for some distance. The result is that water wells historically drilled close to the shoreline are “salted out” as the interface between fresh and salt waters (i.e., the pressure balance point) has steadfastly moved onshore.

FIG. 1 illustrates a typical fresh water system at a coastal location. Fresh water from rain and freshwater streams percolates into the soil and flows within an aquifer 1 from locations inland to below a coastal area 2 to below the ocean floor 3. If little fresh water is extracted from the aquifer 1, the water pressure within the aquifer 1 is often higher than the pressure at the ocean floor 3, so that no sea water percolates into the aquifer 1. In the fresh water system illustrated in FIG. 1, a salt/fresh water interface 22 is maintained downstream of first wells 4 located near the ocean 5.

However, as more and more fresh water is extracted from the aquifer 1 (in FIG. 1, from the first wells 4, from second wells 6 located further inland from the first wells 4 and from extraction field wells 7 located further inland from the second wells 6), the pressure within the aquifer 1 is reduced as the aquifer 1 approaches the coast. In the system illustrated in FIG. 1, the pressure within the aquifer 1 has been reduced sufficiently to allow seepage of sea water 8 into the aquifer 1 at the coast—which will soon shift the salt/fresh water interface 22 to upstream of first wells 4 and force the shutdown of the first wells 4 (as illustrated in FIGS. 2-4). If the situation illustrated in FIG. 1 is allowed to continue, the seepage of sea water 8 will eventually contaminate more and more of the aquifer 1—forcing the eventual shutdown of the second wells 6 and much, if not all, of the extraction field wells 7.

To combat this seawater intrusion into the onshore portion of these freshwater aquifers 1, steps have been taken to increase the fresh water pressure in the aquifers 1 near the shoreline by injecting fresh water into water wells just inland from the salt/fresh water interface 22—to raise the pressure within the aquifer 1 sufficiently to meet or exceed the pressure of the sea water at the ocean floor 3. Such injection of fresh water forms a pressure barrier which prevents the further seepage of salt water 8 into the aquifer 1 and prevents further landward migration of the salt/fresh water interface 22. FIG. 2 illustrates such technology.

In FIG. 2, the fresh water system illustrated in FIG. 1 has been modified. The first wells 4 have been taken out of service and the second wells 6 have been converted from extraction wells to a plurality of spaced apart injection wells. Fresh water is injected into the second wells 6 causing the water pressure within the aquifer 1 to rise. Sufficient fresh water is injected to raise the water pressure within the aquifer 1 to beyond the pressure required to prevent seepage of sea water 8 upstream of these injection wells 6. Thus, such injection wells 6 halt the historic migration of sea water upstream within the aquifer 1 as fresh water is extracted in upstream wells 7. For this reason, these injection wells 6 are often termed “barrier wells.”

The first such injection barrier against further seawater intrusion was established in Los Angeles County in 1953. Today in Southern California, there are four separate injection barriers which comprise 324 water injection wells spread over a distance of about 20 miles.

An obvious problem, however, with maintaining such injection barriers is the required depletion of existing fresh water reserves to the injection wells. Accordingly, there is a need for ways to maintain injection barriers which reduce the depletion of existing fresh water reserves—in an efficient and cost effective manner.

### SUMMARY

The invention satisfies this need. In one aspect, the invention is a system for reducing salt water intrusion into a fresh water aquifer, the system comprising: a) removal means for removing brackish water from the aquifer at a first distance from the ocean; h) generating means for introducing the removed brackish water into a desalination system to generate a first stream of water with a first salt content and a second stream of water having a second salt content, the first salt content being less than the second salt content and less than the salt content of the removed brackish water; and c) introduction means for introducing at least a portion of the first stream of water into the aquifer via a barrier well at a second distance from the ocean, the second distance being greater than the first distance.

In one embodiment of the system of the invention, the system comprises: a) a brackish water extraction well for removing brackish water from the aquifer at a first distance from the ocean; b) a desalination system for accepting the removed brackish water from the brackish water extraction well and generating a first stream of water with a first salt content and a second stream of water having a second salt content, the first salt content being less than the second salt content and less than the salt content of the removed brackish water; and c) a barrier well for introducing at least a portion of the first stream of water into the aquifer at a second distance from the ocean, the second distance being greater than the first distance.

In another aspect, the invention is a method of employing the system of the invention to reduce salt water intrusion into a fresh water aquifer. The method comprises the steps of: a) removing brackish water from the aquifer via an brackish water extraction well at a first distance from the ocean; b) introducing the removed brackish water into a desalination system to generate a first stream of water with a first salt content and a second stream of water having a second salt content, the first salt content being less than the second salt content and less than the salt content of the removed brackish water; and c) introducing at least a portion of the first stream of water into the aquifer via a barrier well at a second distance from the ocean, the second distance being Greater than the first distance.

### DRAWINGS

These and other features, aspects and advantages of the present invention will become better understood with reference to the following description, appended claims, and accompanying drawings where:

FIG. 1 is a cross-sectional sketch of a coastal fresh water system of the prior art;

FIG. 2 is a cross-sectional sketch of the coastal fresh water system of FIG. 1, modified pursuant to the prior art;

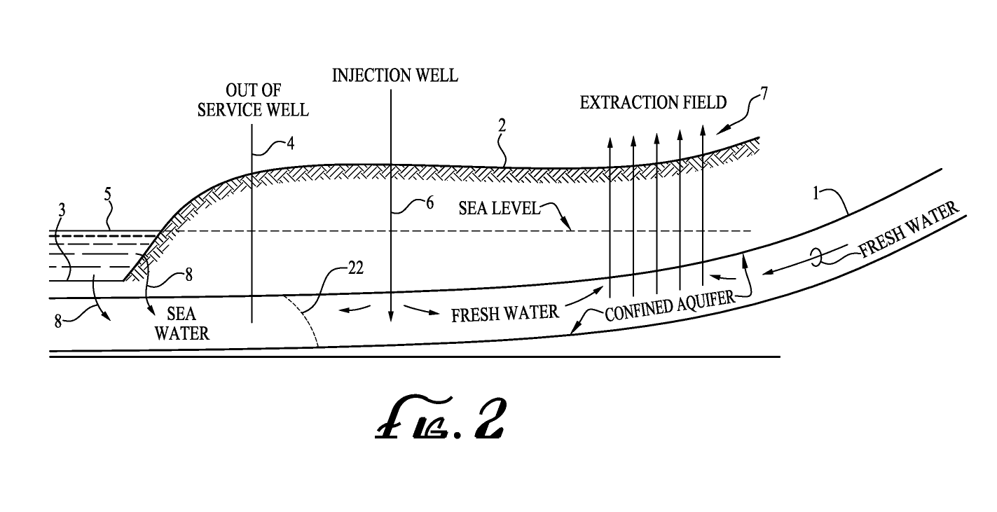

FIG. 3 is a cross-sectional sketch of the coastal fresh water system of FIG. 2, modified to provide a first embodiment of a coastal fresh water system having features of the invention; and

FIG. 4 is a cross-sectional sketch of a second embodiment of a coastal fresh water system having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

### Definitions

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers, ingredients or steps.

As used in this disclosure, the term “greywater” (also commonly spelled graywater, grey water, and gray water) is defined as waste water having a low contaminant content generated typically from domestic activities, such as showering, bathing, washing and laundry, “Greywater” does not include waste water having a high contaminate content, such as waste water generated from sewage and many industrial processes.

As used in this disclosure, the term “brackish water” is defined as water having a TDS content of at least about 500 mg/L, but generally less than that of sea water. Brackish water can be described as low TDS brackish water (brackish water typically having a total dissolved solids content of at least about 1,000 TDS, but generally less 10,000 mg/L TDS) and high TDS brackish water (brackish water typically having a total dissolved solids content of at least about 10,000 mg/L TDS, but generally less than that of sea water).

### The Invention

In one aspect, the invention is a system 10 for reducing salt water intrusion into a fresh water aquifer comprising: a) removal means 19 for removing brackish water 9 from the aquifer 1 at a first distance from the ocean 5; b) generating means 20 for generating a first stream of water 12 with a first salt content and a second stream of water 13 having a second salt content, the first salt content being less than the second salt content and less than the salt content of the removed brackish water 9; and c) introduction means 21 for introducing at least a portion of the first stream of water 12 into the aquifer 1 at a second distance from the ocean 5, the second distance being greater than the first distance.

The first distance is typically between about 0.5 miles and about 2 miles. The second distance is typically between about 2 miles and about 5 miles.

The system can further comprise lines 14 to direct the second stream of water 13 into the ocean 5.

The system of the invention 10 can further comprising lines 15 for combining the second stream 13 with non-potable water to generate a combined stream which is introduction into the ocean 5, wherein the salt content of the combined stream is less than the salt content of the ocean 5.

In the system of the invention, the non-potable water can be grey water.

The system can further comprise lines 16 to introduce the second stream of water 13 into an injection well of a petroleum field.

The system can further comprise the removal of water from the second stream 13 to generate salt.

Typically, in the system of the invention 10 the salt content of the brackish water 9 removed via the removal means 19 for removing brackish water 9 from the aquifer 1 is from about 500 mg/L to about 30,000 mg/L TDS, more typically from about 1,000 mg/L to about 20,000 mg/L TDS, still more typically from about 1,000 mg/L to about 5,000 mg/L IDS, such as from about 1,000 mg/L to about 2,000 mg/L TDS.

In one embodiment of the system of the invention 10, the removal means 19 for removing brackish water 9 from the aquifer 1 is provided by a brackish water extraction well 17, the generating means 20 for introducing the removed brackish water 9 into a desalination system is provided by a desalination system 11, and the introduction means 21 for introducing at least a portion of the first stream of water 12 into the aquifer 1 is provided by a barrier well 6. Thus, in this embodiment, the system comprises: a) a brackish water extraction well 17 for removing brackish water 9 from the aquifer 1 at a first distance from the ocean 5; b) a desalination system 11 for accepting the removed brackish water 9 from the brackish water extraction well 17 and generating a first stream of water 12 with a first salt content and a second stream of water 13 having a second salt content, the first salt content being less than the second salt content and less than the salt content of the removed brackish water 9; and c) a barrier well 17 for introducing at least a portion of the first stream of water 12 into the aquifer 1 at a second distance from the ocean 5, the second distance being greater than the first distance.

The brackish water extraction well 17 can be a newly drilled well or it can be a preexisting well.

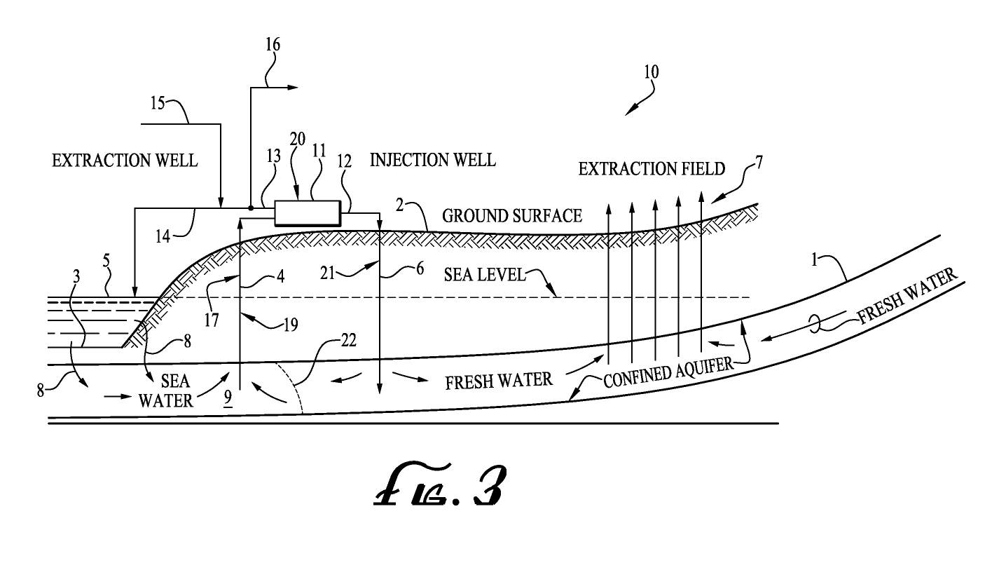

In another aspect, the invention is a method of employing the system of the invention 10 to reduce salt water intrusion into a fresh water aquifer 1. The method comprises the steps of: a) removing brackish water 9 from the aquifer 1 via an brackish water extraction well 17 at a first distance from the ocean 5; b) introducing the removed brackish water 9 into a desalination system 11 to generate a first stream of water 12 with a first salt content and a second stream of water 13 having a second salt content, the first salt content being less than the second salt content and less than the salt content of the removed brackish water 9; and c) introducing at least a portion of the first stream of water 12 into the aquifer 1 via a barrier well 6 at a second distance from the ocean 5, the second distance being greater than the first distance. One embodiment of this aspect is illustrated in FIG. 3.

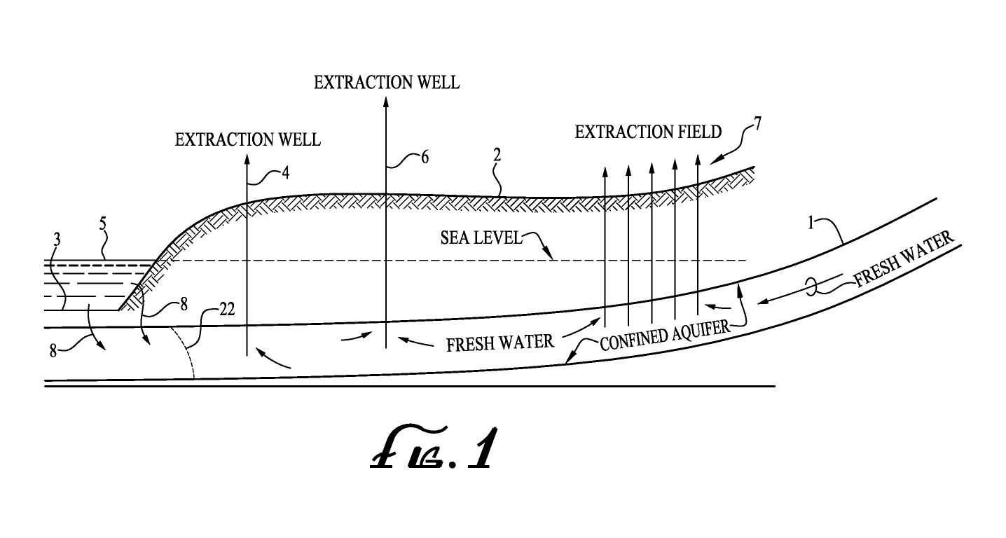

In FIG. 3, the fresh water system illustrated in FIG. 1 has been modified to provide a first embodiment of a fresh water system 10 having features of the invention. The first wells 4 have again been put into service as brackish water extraction wells 17, that are employed to extract brackish water 9 from the aquifer 1. The brackish water 9 is processed in a desalination system 11 to convert the brackish water 9 into two streams, a first stream 12 having a lesser content of salt than the brackish water 9 and a second stream 13 having a greater content of salt than the brackish water 9. The first stream is then injected into the aquifer 1 via the second wells 6 (now converted in FIG. 3 to injection wells) to provide all or a portion of the fresh water necessary to raise the water pressure within the aquifer 1 to beyond the pressure required to prevent seepage of sea water 8 upstream of the second wells 6.

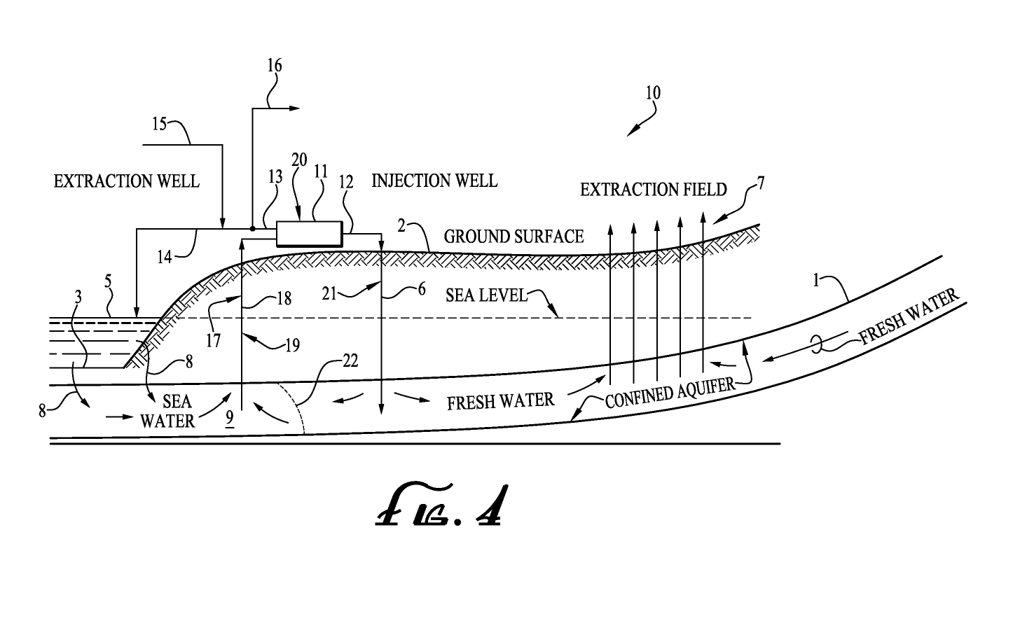

FIG. 4 illustrates a second embodiment of this aspect having features of the invention, wherein first wells 4 do not exist at the site or are unusable. The second embodiment illustrated in FIG. 4 is identical to the first embodiment illustrated in FIG. 3, except that, in the embodiment illustrated in FIG. 4, new wells 18 are drilled at a location more proximate to the ocean 5 than second wells 6 to provide the brackish water extraction wells 17.

Thus in this aspect, the invention is a method for reducing salt water intrusion into a fresh water aquifer 1 comprising the steps of: a) removing brackish water 9 via a brackish water extraction well 17 at a first distance from the ocean 5; b) introducing the removed brackish water 9 into a desalination system 11 to generate a first stream of water 12 with a first salt content and a second stream of water 13 having a second salt content, the first salt content being less than the second salt content and less than the salt content of the brackish water 9; and c) introducing at least a portion of the first stream of water 12 into a barrier well 6 into the aquifer 1 at a second distance from the ocean 5, the second distance being greater than the first distance.

As noted above, the first distance is typically between about 0.5 miles and about 2 miles, The second distance is typically between about 2 miles and about 5 miles.

Also as noted above, the method of can comprise the additional step of prior to step a), drilling a new well to provide the brackish water extraction well 17. However, as illustrated in FIG. 3, the brackish water extraction well can be a preexisting well, such as a preexisting extraction well 4.

The method can comprise the additional step of introducing the second stream of water 13 into the ocean 5 via line 14.

The method can also comprise the additional step of combining the second stream 13 with non-potable water from line 15 to generate a combined stream for introduction into the ocean 5, the salt content of the combined stream being less than the salt content of the ocean 5. Such non-potable water can be grey water.

The method can also comprise the additional step of introducing he second stream 13 of water into an injection well of a petroleum field via line 16.

The method can also comprise the additional step of removing water from the second stream 13 to generate salt.

As in the system of the invention 10, the salt content of the brackish water 9 in the method of the invention is typically from about 1,000 mg/L to about 30,000 mg/L TDS, more typically from about 1,000 mg/L to about 20,000 mg/L TDS, still more typically from about 1,000 mg/L to about 5,000 mg/L IDS, such as from about 1,000 mg/L to about 2,000 mg/L TDS.

The invention has the advantage of allowing the use of a plurality of small, often portable, desalination systems 11—rather than having to rely on a single massive fixed desalination system. Such small desalination systems 11 provide flexibility of operation, ease of maintenance, protection against system-wide desalination system shutdowns and marked reduction in environmental challenges. Small desalination systems 11 which can be used in the invention include, but are not limited to, Newterra EPRO 6000 SW, manufactured by Newterra of Lakeland, Fla., GE SeaTECH-252, manufactured by GE Power & Water of Trevose, Pa. and Desalitech ReFlex MAX 1200, manufactured by Desalitech of Newton, Mass.

What is claimed is:

1. A method for reducing salt water intrusion into a fresh water aquifer comprising the steps of: a) removing brackish water from the aquifer via an brackish water extraction well at a first distance from the ocean; b) introducing the removed brackish water into a desalination system to generate a first stream of water with a first salt content and a second stream of water having a second salt content, the first salt content being less than the second salt content and less than the salt content of the removed brackish water; and c) introducing at least a portion of the first stream of water into the aquifer via a barrier well at a second distance from the ocean, the second distance being greater than the first distance,

2. The method of claim 1 comprising the additional step of, prior to step a), drilling a new well to provide the brackish water extraction well.

3. The method of claim 1 wherein the brackish water extraction well is a preexisting well.

4. The method of claim 1 comprising the additional step of introducing the second stream of water into the ocean.

5. The method of claim 1 comprising the additional step of combining the second stream with non-potable water to generate a combined stream for introduction into the ocean, the salt content of the combined stream being less than the salt content of the ocean.

6. The method of claim 5 wherein the non-potable water is grey water.

7. The method of claim 1 comprising the additional step of introducing the second stream of water into an injection well of a petroleum field.

8. The method of claim 1 comprising the additional step of removing water from the second stream to generate salt.

9. The method of claim 1 wherein the TDS content of the brackish water is from about 1000 mg/L to about 30,000 mg/L TDS.

10. The method of claim 1 wherein the TDS content of the brackish water is from about 1,000 mg/L to about 20,000 mg/L TDS.

11. A system for reducing salt water intrusion into a fresh water aquifer comprising: a) removal means for removing brackish water from the aquifer at a first distance from the ocean; b) generating means for introducing the removed brackish water into a desalination system to generate a first stream of water with a first salt content and a second stream of water having a second salt content, the first salt content being less than the second salt content and less than the salt content of the removed brackish water; and c) introduction means for introducing at least a portion of the first stream of water into the aquifer via a barrier well at a second distance from the ocean, the second distance being greater than the first distance.

12. The system of claim 11 wherein the brackish water extraction well is a newly drilled well.

13. The system of claim 11 wherein the brackish water extraction well is a preexisting well.

14. The system of claim 11 further comprising lines to direct the second stream of water into the ocean.

15. The system of claim 11 further comprising lines for combining the second stream with non-potable water to generate a combined stream which is introduction into the ocean, wherein the salt content of the combined stream being less than the salt content of the ocean.

16. A system for reducing salt water intrusion into a fresh water aquifer comprising: a) a brackish water extraction well for removing brackish water from the aquifer at a first distance from the ocean; b) a desalination system for accepting the removed brackish water from the brackish water extraction well and generating a first stream of water with a first salt content and a second stream of water having a second salt content, the first salt content being less than the second salt content and less than the salt content of the removed brackish water; and c) a barrier well for introducing at least a portion of the first stream of water into the aquifer at a second distance from the ocean, the second distance being greater than the first distance.

17. The system of claim 16 wherein the brackish water extraction well is a newly drilled well.

18. The system of claim 16 wherein the brackish water extraction well is a preexisting well.

19. The system of claim 16 further comprising lines to direct the second stream of water into the ocean.

20. The system of claim 16 further comprising lines for combining the second stream with non-potable water to generate a combined stream which is introduction into the ocean, wherein the salt content of the combined stream being less than the salt content of the ocean.
